(19) United States
(12) Patent Application Publication
(10) Pub. No.: US 2023/0015143 A1
(43) Pub. Date: Jan. 19, 2023

(54) METHODS OF FABRICATING BIPOLAR SOLID STATE BATTERIES

(71) Applicant: GM GLOBAL TECHNOLOGY OPERATIONS LLC, Detroit, MI (US)

(72) Inventors: Qili SU, Shanghai (CN); Mengyan HOU, Shanghai (CN); Meiyuan WU, Shanghai (CN); Haijing LIU, Shanghai (CN)

(73) Assignee: GM GLOBAL TECHNOLOGY OPERATIONS LLC, Detroit, MI (US)

(21) Appl. No.: 17/688,445

(22) Filed: Mar. 7, 2022

(30) Foreign Application Priority Data
Jul. 15, 2021 (CN) 2021108005997

(51) Int. Cl. H01M 10/0562; H01M 10/0525; H01M 10/0583; H01M 10/04; H01M 4/04

(52) U.S. Cl. CPC H01M 10/0562; H01M 10/0525; H01M 10/0583; H01M 10/0468; H01M 4/0404; H01M 2300/002; H01M 2300/0094

(57) ABSTRACT

A method for forming a solid-state battery is provided. The method includes disposing one or more cell units along a continuous current collector to form a stack precursor. In some examples, disposing of the one or more cell units along the continuous current collector includes concurrently disposing the one or more cell units along the continuous current collector and winding the continuous current collector to form a stack. In other examples, the continuous current collector is a z-folded current collector and the disposing the one or more cell units along the continuous current collector includes inserting the one or more cell units into one or more pockets formed by folds of the continuous current collector. The method may further include applying heat, pressure, or a combination of heat and pressure to the stack precursor to form a compressed stack, and cutting the continuous current collector to form the solid-state battery.

### CROSS-REFERENCE TO RELATED APPLICATIONS

This application claims the benefit and priority of Chinese Application No. 202110800599.7, filed Jul. 15, 2021. The entire disclosure of the above application is incorporated herein by reference.

### Introduction

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. However, common methods of manufacturing solid-state batteries, and more particularly, bipolar solid-state batteries, have low rates of manufacturing productivity. Accordingly, it would be desirable to develop methods for making high-performance solid-state batteries that improve manufacturing processes.

### SUMMARY

This section provides a general summary of the disclosure, and is not a comprehensive disclosure of its full scope or all of its features.

The present disclosure relates to solid-state batteries, for example bipolar solid-state batteries, and methods of forming the same.

In various aspects, the present disclosure provides a method for forming a solid-state battery. The method may include disposing one or more cell units along a continuous current collector to form a stack precursor. Each cell unit may include one or more first electrodes, one or more second electrodes, and one or more electrolyte layers physically separating the one or more first electrodes and the one or more second electrodes. The method may further include applying heat, pressure, or a combination of heat and pressure to the stack precursor to form a compressed stack, and cutting the continuous current collector to form the solid-state battery.

In one aspect, the disposing of the one or more cell units along the continuous current collector may include concurrently disposing the one or more cell units along the continuous current collector and winding the continuous current collector to form a stack.

In one aspect, the concurrently disposing of the one or more cell units along the continuous current collector and winding the continuous current collector to form the stack may include disposing a first cell of the one or more cell units on a first exposed surface of the continuous current collector; winding the continuous current collector 180 degrees about a central axis so to expose a second exposed surface of the continuous current collector; disposing a second cell of the one or more cell units on a second exposed surface of the continuous current collector; and winding the continuous current collector 180 degrees about a central axis so to expose a third exposed surface of the continuous current collector.

In one aspect, the continuous current collector may be a z-folded current collector and the disposing the one or more cell units along the continuous current collector may include inserting the one or more cell units into one or more pockets formed by folds of the continuous current collector.

In one aspect, the disposing of the one or more cell units along the continuous current collector may include disposing a first cell unit of the one or more cell units on or adjacent to a first surface of the continuous current collector; folding the continuous current collector to form a first pocket that surrounds the first cell unit; disposing a second cell unit of the one or more cell units on or adjacent to a second surface of the continuous current collector that is defined by an exterior-facing surface of the first pocket; and folding the continuous current collector to form a second pocket that surrounds the second cell unit.

In one aspect, the continuous current collector may have a thickness greater than or equal to about 2 μm to less or equal to about 60 μm.

In one aspect, the continuous current collector may be a cladded foil. The cladded foil may include a first layer parallel with a second layer.

In one aspect, one or more anode tabs and one or more cathode tabs may be defined in the continuous current collector.

In one aspect, the continuous current collector may include one or more surfaces at least partially coated with one or more electrically conductive adhesive layers.

In one aspect, the continuous current collector may include one or more surfaces partially coated with a polymeric coating. The polymeric coating may have a thickness greater than or equal to about 2 μm to less or equal to about 200 μm.

In one aspect, the method may further includes disposing a polymeric coating on one or more first regions of a first surface of the continuous current collector. The one or more first regions may be spaced apart by one or more second regions and the one or more cell units may be disposed on or adjacent to the one or more second regions. Cutting the continuous current collector may include removing at least a portion of each of the one or more polymeric coatings.

In one aspect, the polymeric coating may include one or more polymeric materials selected from the group consisting of: urethane resin, polyamide resin, polyolefin resin, polyethylene resin, polypropylene resin, silicone, polyimide resin, epoxy resin, acrylic resin, ethylene-propylenediene rubber (EPDM), isocyanate adhesive, acrylic resin adhesive, cyanoacrylate adhesive, or any combination thereof.

In one aspect, the stack precursor may be heated to a temperature greater than or equal to about 50° C. to less than or equal to about 350° C. to form the compressed stack.

In one aspect, a pressure greater than or equal to about 5 PSI to less than or equal to about 300 PSI may be applied to the stack precursor to form the compressed stack.

In various aspects, the present disclosure provides a method for forming a solid-state battery. The method may include disposing one or more cell units along a continuous current collector and concurrently winding the continuous current collector to form a stack precursor. Each cell unit may include one or more first electrodes, one or more second electrodes, and one or more electrolyte layers physically separating the one or more first electrodes and the one or more second electrodes. The method may further include applying heat, pressure, or a combination of heat and pressure to the stack precursor to form a compressed stack and cutting the continuous current collector us to form the solid-state battery. Applying heat to the stack precursor may include heating the stack to a temperature greater than or equal to about 50° C. to less than or equal to about 350° C. Applying pressure to the stack precursor may include pressing the stack at a pressure greater than or equal to about 5 PSI to less than or equal to about 300 PSI.

In one aspect, the current collector may be one of a metal foil and a cladded foil.

In one aspect, one or more anode tabs and one or more cathode tabs may be defined in the continuous current collector.

In one aspect, the method may further include disposing a polymeric coating on one or more first regions of a first surface of the continuous current collector. The one or more first regions may be spaced apart by one or more second regions and the one or more cell units may be disposed on or adjacent to the one or more second regions. Cutting the continuous current collector may include removing at least a portion of each of the one or more polymeric coatings.

In various aspects, the present disclosure provides a method of forming a solid-state battery. The method may include disposing one or more cell units along a first surface of a continuous current collector to form a stack precursor. The continuous current collector may be a z-folded current collector. Each cell unit may include one or more first electrodes, one or more second electrodes, and one or more electrolyte layers physically separating the one or more first electrodes and the one or more second electrode. The method may further include applying heat, pressure, or a combination of heat and pressure to the stack precursor to form a compressed stack and cutting the continuous current collector to form the solid-state battery. Applying heat to the stack precursor may include heating the stack to a temperature greater than or equal to about 50° C. to less than or equal to about 350° C. Applying pressure to the stack precursor may include pressing the stack at a pressure greater than or equal to about 5 PSI to less than or equal to about 300 PSI.

In one aspect, the current collector may be one of a metal foil and a cladded foil.

In one aspect, one or more anode tabs and one or more cathode tabs may be defined in the continuous current collector.

In one aspect, the method may further include disposing a polymeric coating on one or more first regions of a first surface of the continuous current collector. The one or more first regions may be spaced apart by one or more second regions and the one or more cell units may be disposed on or adjacent to the one or more second regions. Cutting the continuous current collector may include removing at least a portion of each of the one or more polymeric coatings.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery in accordance with various aspects of the present disclosure;

FIG. 2A is an illustration of an example method for forming a solid-state battery, like the solid-state battery illustrated in FIG. 1, using z-type stacking process, in accordance with various aspects of the present disclosure;

FIG. 2B is another illustration of the example method for forming a solid-state battery illustrated in FIG. 2A;

FIG. 2C is another illustration of the example method for forming a solid-state battery illustrated in FIG. 2A;

FIG. 2D is another illustration of the example method for forming a solid-state battery illustrated in FIG. 2A;

FIG. 3 is an example current collector for use in forming a solid-state battery, like the solid-state battery illustrated in FIG. 1, in accordance with various aspects of the present disclosure;

FIG. 4A is an illustration of another example method for forming a solid-state battery, like the solid-state battery illustrated in FIG. 1, using a winding stacking process, in accordance with various aspects of the present disclosure;

FIG. 4B is another illustration of the example method for forming a solid-state battery illustrated in FIG. 4A;

FIG. 4C is another illustration of the example method for forming a solid-state battery illustrated in FIG. 4A;

FIG. 4D is another illustration of the example method for forming a solid-state battery illustrated in FIG. 4A;

FIG. 5A is an illustration of another example method for forming a solid-state battery, like the solid-state battery illustrated in FIG. 1, using a winding stacking process, in accordance with various aspects of the present disclosure;

FIG. 5B is another illustration of the example method for forming a solid-state battery illustrated in FIG. 5A;

FIG. 5C is another illustration of the example method for forming a solid-state battery illustrated in FIG. 5A;

FIG. 5D is another illustration of the example method for forming a solid-state battery illustrated in FIG. 5A;

FIG. 6 is another example current collector for use in forming a solid-state battery, like the solid-state battery illustrated in FIG. 1, in accordance with various aspects of the present disclosure;

FIG. 7A is an illustration of another example method for forming a solid-state battery, like the solid-state battery illustrated in FIG. 1, using a winding stacking process, in accordance with various aspects of the present disclosure;

FIG. 7B is another illustration of the example method for forming a solid-state battery illustrated in FIG. 7A;

FIG. 7C is another illustration of the example method for forming a solid-state battery illustrated in FIG. 7A;

FIG. 7D is another illustration of the example method for forming a solid-state battery illustrated in FIG. 7A;

FIG. 8A is another example current collector for use in forming a solid-state battery in accordance with various aspects of the present disclosure;

FIG. 8B is another example current collector for use in forming a solid-state battery in accordance with various aspects of the present disclosure;

FIG. 9A is an illustration of an example winding stacking process in accordance with various aspects of the present disclosure;

FIG. 9B is another illustration of the example winding stacking process illustrated in FIG. 9A;

FIG. 9C is another illustration of the example winding stacking process illustrated in FIG. 9A; and

FIG. 9D is another illustration of the example winding stacking process illustrated in FIG. 9A.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs), for example only, bipolar solid-state batteries, and methods of forming and using the same. Solid-state batteries may include at least one solid component, for example, at least one solid electrode, but may also include semi-solid or gel, liquid, or gas components, in certain variations. Solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

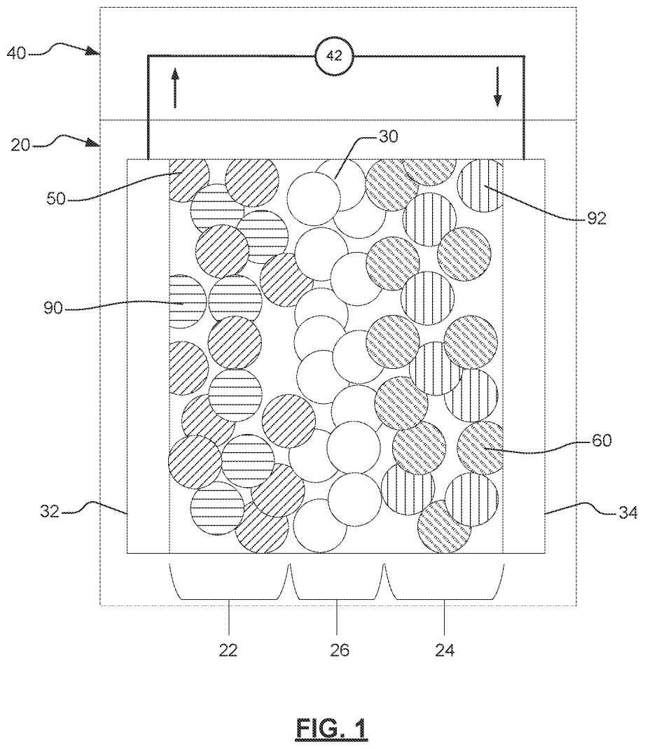

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes. The electrolyte layer 26 is a solid-state or semi-solid state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network.

A negative electrode current collector 32 may be positioned at or near the negative electrode 22. A positive electrode current collector 34 may be positioned at or near the positive electrode 24. The negative electrode current collector 32 may be formed from copper or any other appropriate electrically conductive material known to those of skill in the art. The positive electrode current collector 34 may be formed from aluminum or any other electrically conductive material known to those of skill in the art. The negative electrode current collector 32 and the positive electrode current collector 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34).

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Though the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the solid-state electrolyte 26 layer.

In many configurations, each of the negative electrode current collector 32, the negative electrode 22, the electrolyte layer 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the solid-state electrolyte layer 26 provides electrical separation—preventing physical contact—between the negative electrode 22 and the positive electrode 24. The solid-state electrolyte layer 26 also provides a minimal resistance path for internal passage of ions. In various aspects, the solid-state electrolyte layer 26 may be defined by a first plurality of solid-state electrolyte particles 30. For example, the solid-state electrolyte layer 26 may be in the form of a layer or a composite that comprises the first plurality of solid-state electrolyte particles 30. The solid-state electrolyte particles 30 may have an average particle diameter greater than or equal to about 0.02 μm to less than or equal to about 20 μm, optionally greater than or equal to about 0.1 μm to less than or equal to about 10 μm, and in certain aspects, optionally greater than or equal to about 0.1 μm to less than or equal to about 1 μm. The solid-state electrolyte layer 26 may be in the form of a layer having a thickness greater than or equal to about 5 μm to less than or equal to about 200 μm, optionally greater than or equal to about 10 μm to less than or equal to about 100 μm, optionally about 40 μm, and in certain aspects, optionally about 30 μm.

The solid-state electrolyte particles 30 may comprise one or more sulfide-based particles, oxide-based particles, metal-doped or aliovalent-substituted oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋GeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂₀₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI·0.6Li₄SnS₄, and Li₁₁Si₂PS₁₂ Example pseudoquaternary sulfide systems include Li₂O—Li₂S—P₂S₅— P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.351}[Sn_{0.27}Si_{1.08}]P_{1.65}S₁₂.

In certain variations, the nitride-based particles may include, for example only, Li₃N, Li₇PN₄, LiSi₂N₃, and combinations thereof; the hydride-based particles may include, for example only, LiBH₄, LiBH₄—LiX (where x=Cl, Br, or I), LiNH₂, Li₂NH, LiBH₄—LiNH₂, Li₃AlH₆, and combinations thereof; the halide-based particles may include, for example only, LiI, Li₃InCl₆, Li₂CdC₁₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O—B₂O₃—P₂O₅, and combinations thereof.

In various aspects, the first plurality of solid-state electrolyte particles 30 may include one or more electrolyte materials selected from the group consisting of: Li₂S—P₂S₅ system, Li₂S—P₂S₅—MOₓ system (where 1<x<7), Li₂S— P₂S₅—MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1-x)P₂S₅-xLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}AS_{0.16}S₄, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), LiMM′(PO₄)₃ (where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-8)}TiO₃ (where 0<x<0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), LiI—Li₄SnS₄, Li₄SnS₄, Li₃N, Li₇PN₄, LiSi₂N₃, LiBH₄, LiBH₄—LiX (where x=Cl, Br, or I), LiNH₂, Li₂NH, LiBH₄—LiNH₂, Li₃AlH₆, LiI, Li₃InCl₆, Li₂CdC₁₄, Li₂MgCl₄, LiCdI₄, Li₂ZnI₄, Li₃OCl, Li₂B₄O₇, Li₂O—B₂O₃—P₂O₅, and combinations thereof.

In certain variations, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1−x)P₂S₅₋ₓLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, and combinations thereof.

Although not illustrated, the skilled artisan will recognize that in certain instances, one or more binder particles may be mixed with the solid-state electrolyte particles 30. For example, in certain aspects the solid-state electrolyte layer 26 may include greater than or equal to about 0 wt. % to less than or equal to about 10 wt. %, and in certain aspects, optionally greater than or equal to about 0.5 wt. % to less than or equal to about 10 wt. %, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

In certain instances, the solid-state electrolyte particles 30 (and the optionally one or more binder particles) may be wetted by a small amount of liquid electrolyte, for example, to improve ionic conduction between the solid-state electrolyte particles 30. The solid-state electrolyte particles 30 may be wetted by greater than or equal to about 0 wt. % to less than or equal to about 40 wt. %, optionally greater than or equal to about 0.1 wt. % to less than or equal to about 40 wt. %, and in certain aspects, optionally greater than or equal to about 5 wt. % to less or equal to about 10 wt. %, of the liquid electrolyte, based on the weight of the solid-state electrolyte particles 30. In certain variations, Li₇P₃S₁₁ may be wetted by an ionic liquid electrolyte including LiTFSI-triethylene glycol dimethyl ether.

The negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50 and greater than or equal to about 0 wt. % to less than or equal to about 50 wt. %, and in certain aspects, optionally greater than or equal to about 5 wt. % to less than or equal to about 20 wt. %, of the second plurality of solid-state electrolyte particles 90.

The second plurality of solid-state electrolyte particles 90 may be the same as or different from the first plurality of solid-state electrolyte particles 30. In certain variations, the negative solid-state electroactive particles 50 may be lithium-based, for example, a lithium alloy. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄Ti₅O₁₂); one or more metal oxides, such as TiO₂ and/or V₂O₅; and metal sulfides, such as FeS. Thus, the negative solid-state electroactive particles 50 may be selected from the group including, for example only, lithium, graphite, graphene, hard carbon, soft carbon, carbon nanotubes, silicon, silicon-containing alloys, tin-containing alloys, and combinations thereof.

In certain variations, the negative electrode 22 may further include one or more conductive additives and/or binder materials. For example, the negative solid-state electroactive particles 50 (and/or second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90) may be optionally intermingled with binders, such as polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60 and greater than or equal to about 0 wt. % to less than or equal to about 50 wt. %, and in certain aspects, optionally greater than or equal to about 5 wt. % to less than or equal to about 20 wt. %, of the third plurality of solid-state electrolyte particles 92.

The third plurality of solid-state electrolyte particles 92 may be the same as or different from the first and/or second pluralities of solid-state electrolyte particles 30, 90. In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

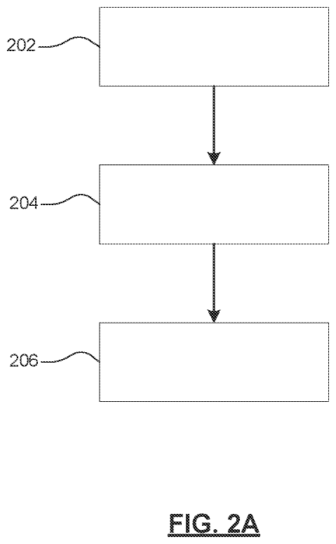

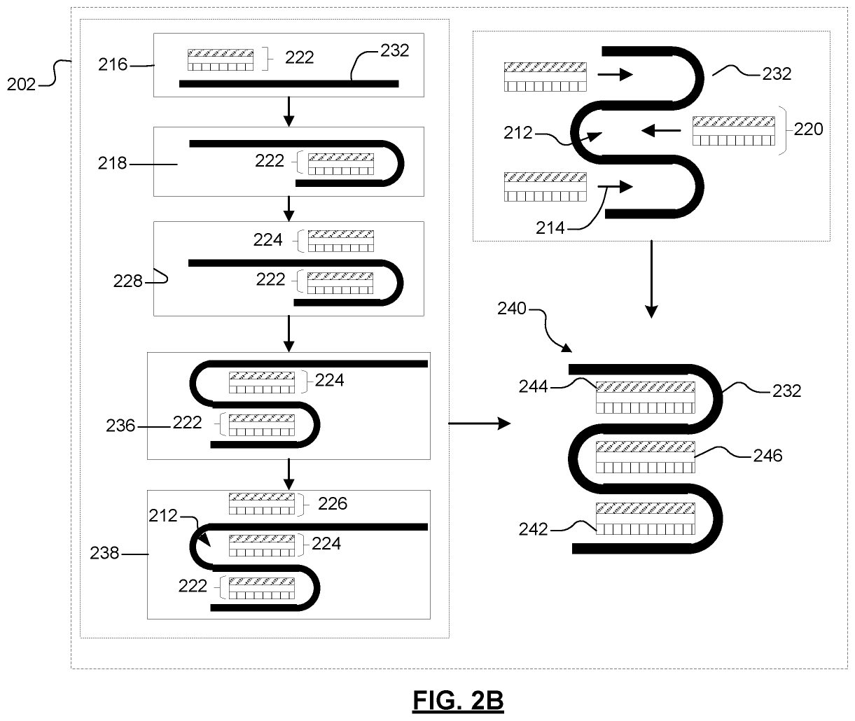

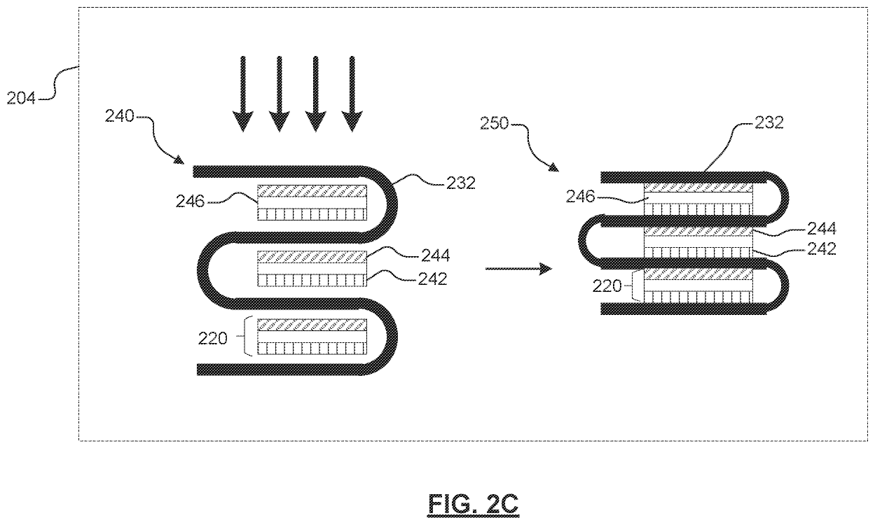

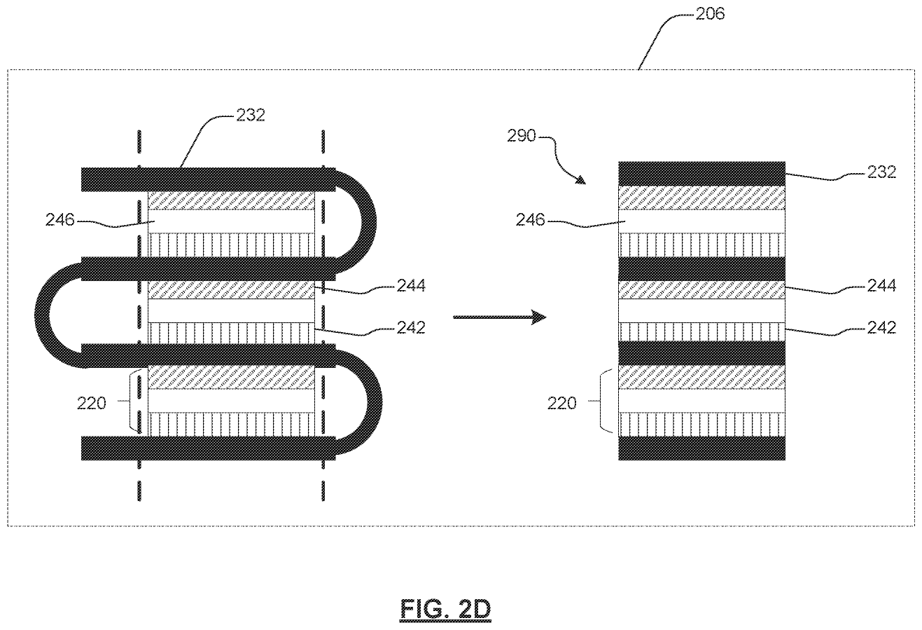

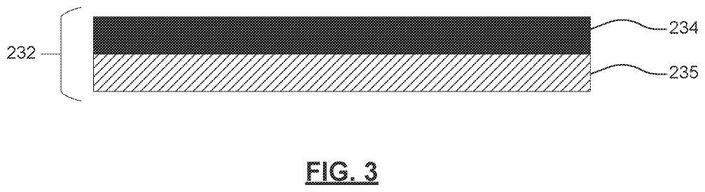

In various aspects, the present disclosure provides methods for fabrication solid-state batteries including a plurality of electrochemical cell units, like battery 20 illustrated in FIG. 1. For example, FIGS. 2A-2D illustrate an example z-type stacking method 200 for forming a solid-state battery 290. The method 200 includes disposing 202 one or more cell units 220 along a continuous bipolar current collector 232 to form a precursor of a stack 240, where the current collector 232 is z-folded. The stack 240 may be further processed, as described further herein, with application of pressure and/or heat to form a consolidated or compressed stack. The current collector 232 may have a thickness greater than or equal to about 2 μm to less or equal to about 60 μm, and in certain aspects, optionally greater than or equal to about 5 μm to less than or equal to about 30 μm.

In various aspects, the current collector 232 may a metal foil including at least one of stainless steel, aluminum, nickel, iron, titanium, copper, tin, or any other electrically conductive material known to those of skill in the art. In other variations, the current collector 232 may be a cladded foil, for example, where one side (e.g., the first side or the second side) of the current collector includes one metal (e.g., first metal) and another side (e.g., the other side of the first side or the second side) of the current collector 232 includes another metal (e.g., second metal). The cladded foil may include, for example only, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). In still other variations, the current collector 232 may be pre-coated, such as carbon-coated aluminum current collectors.

Although not illustrated, in various aspects, one or more electrically conductive adhesive layers or coatings may be formed or coated on one or more surfaces of the current collector 232. The one or more electrically conductive adhesive layers may improve connections between the electrodes and the current collectors. In each instance, the electrically conductive adhesive layer may have a thickness greater than or equal to about 0.5 μm to less than or equal to about 20 μm and may include a polymer and a conductive filler. For example, the electrically conductive adhesive layer may include greater than or equal to about 0.1 wt. % to less than or equal to about 50 wt. % of the polymer and greater than or equal to about 0.1 wt. % to less than or equal to about 50 wt. % of the conductive filler.

The polymer may be selected to be solvent resistant and to provide good adhesion. For example, the polymer may include epoxy, polyimide (polyamic acid), polyester, vinyl ester, thermoplastic polymers (e.g., polyvinylidene difluoride (PVDF)), polyamide, silicone, acrylic, polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and any combination thereof. The conductive filler may include carbon materials (e.g., Super P, carbon black, graphene, carbon nanotubes, carbon nanofibers, and the like), metal powders (e.g., gold (Ag), nickel (Ni), aluminum (Al), and the like), and any combination thereof.

With renewed reference to FIGS. 2A-2D, each of the one or more cell units 220 may include a first electrode 242 separated from a second electrode 244 by an electrolyte layer 246. In certain variations, the first electrode 242 may be a negative electrode similar to the negative electrode 22 illustrated in FIG. 1, and the second electrode 244 may be a positive electrode similar to the positive electrode 24 illustrated in FIG. 1. Although not illustrated, the skilled artisan will appreciate that the first electrode 242 may include a first plurality of solid-state electroactive material particles and optionally a first plurality of solid-state electrolyte particles, and the second electrode 244 may include a second plurality of solid-state electroactive material particles and a second plurality of solid-state electrolyte particles. The first and second pluralities of solid-state electrolyte particles may be the same or different.

The skilled artisan will also appreciate that in various aspects the one or more cell units 220 may take a variety of other configurations. For example, in certain variations, the first electrode 242 may be a positive electrode and the second electrode 244 may be a negative electrode. In other variations, the first electrode 242 may include one or more electroactive material layers disposed on one or more surfaces of a second current collector, and the second electrode 244 may include one or more electroactive material layers disposed on one or more surfaces of a third current collector. The second and third current collectors may be the same as or different and may be the same as or different from the continuous bipolar current collector 232. In still further variation, a combination of the one or more cell units 220 may be disposed at each position (e.g., within each pocket) along the continuous bipolar current collector 232.

As illustrated in FIG. 2B, in certain variations, disposing 202 the one or more cell units 220 along the current collector 232 may include moving 214 the one or more cell units 220 into the pockets 212 formed by the folds of the current collector 232. In other variations, disposing the one or more cell units 220 along the current collector 232 may include disposing the one or more cell units 220 sequentially. For example, a first cell unit 222 of the one or more cell units 220 may be disposed 216 adjacent to a first surface of the current collector 232. The current collector 232 may then be folded 218 so as to from a first pocket that surrounds the first cell unit 222. A second cell unit 224 of the one or more cell units 220 may be then disposed 228 adjacent to a second surface of the current collector 232. The current collector 232 may then be folded 236 again so as to form a second pocket that surrounds the second cell unit 224. A third cell unit 226 of the one or more cell units 220 may be then disposed 238 adjacent to a third surface of the current collector 232. The current collector 232 may then be folded again so as to form a third pocket that surrounds the third cell unit 226.

In various aspects, the method 200 includes applying 204 pressure and/or heat to the stack 240 to form a compressed stack 250, such as illustrated in FIG. 2C. For example, the stack 240 may be heated to a temperature greater than the glass transition temperature and lower than the melting point of the polymers in the one or more electrically conductive adhesive layers or coatings. The stack 240 may be heated to a temperature greater than or equal to about 50° C. to less than or equal to about 350° C. A pressure applied to the stack 240 may be greater than or equal to about 5 PSI to less than or equal to about 300 PSI. In certain variations, a lamination machine such as a platen may be used to apply 204 the pressure and/or heat to the stack 240.

In various aspects, the method 200 includes cutting 206 the continuous current collector 232 so as to form the solid-state battery 290, as illustrated in FIG. 2D. The current collector 232 may be trimmed using a machine die cutter and/or a laser cutter.

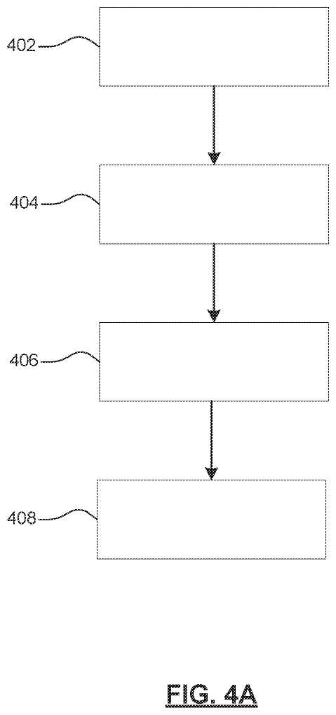

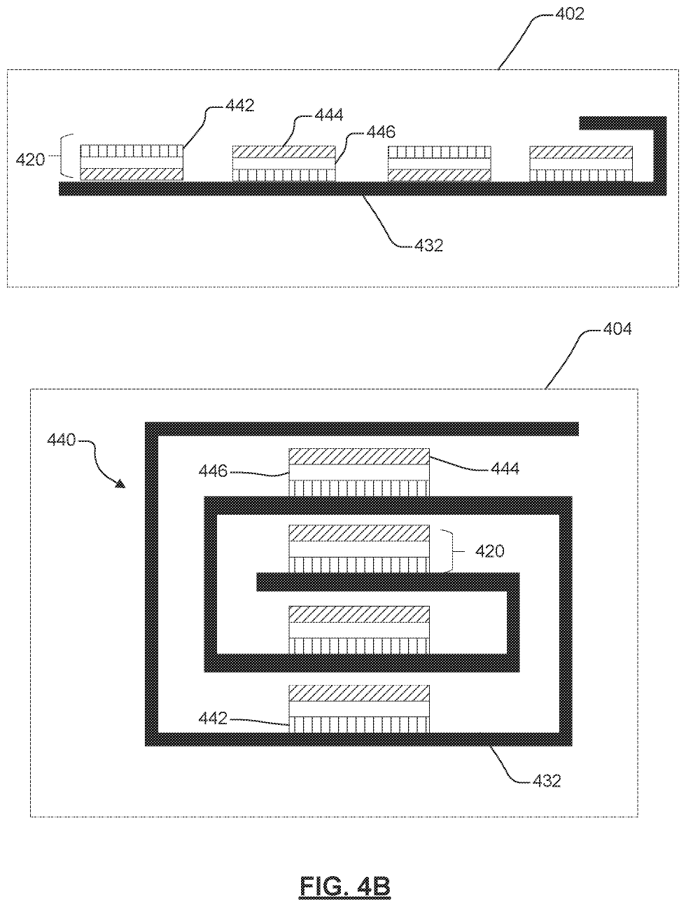

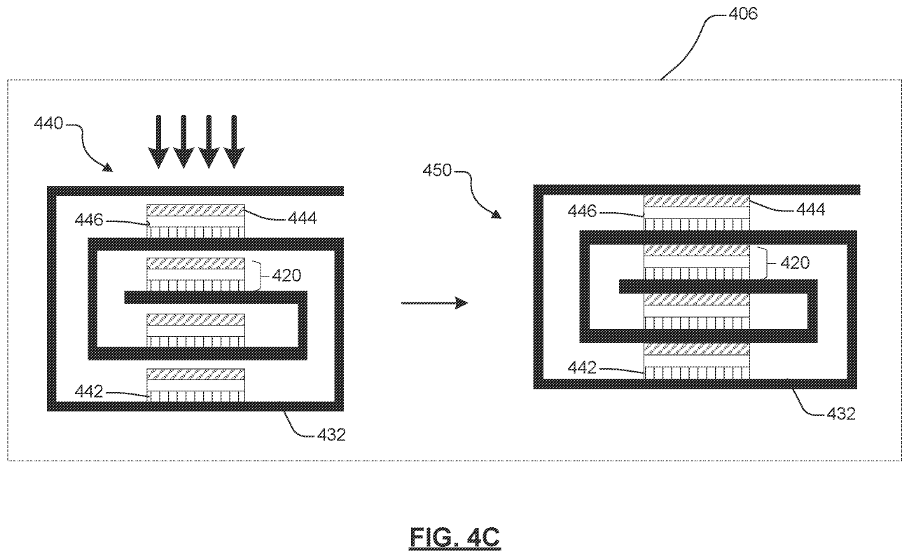

FIGS. 4A-4D illustrate an example winding method 400 for forming a solid-state battery 490. The method 400 includes disposing 402 one or more cell units 420 on or adjacent to a continuous bipolar current collector 432 and concurrently winding 404 the current collector 432 to form a stack 440.

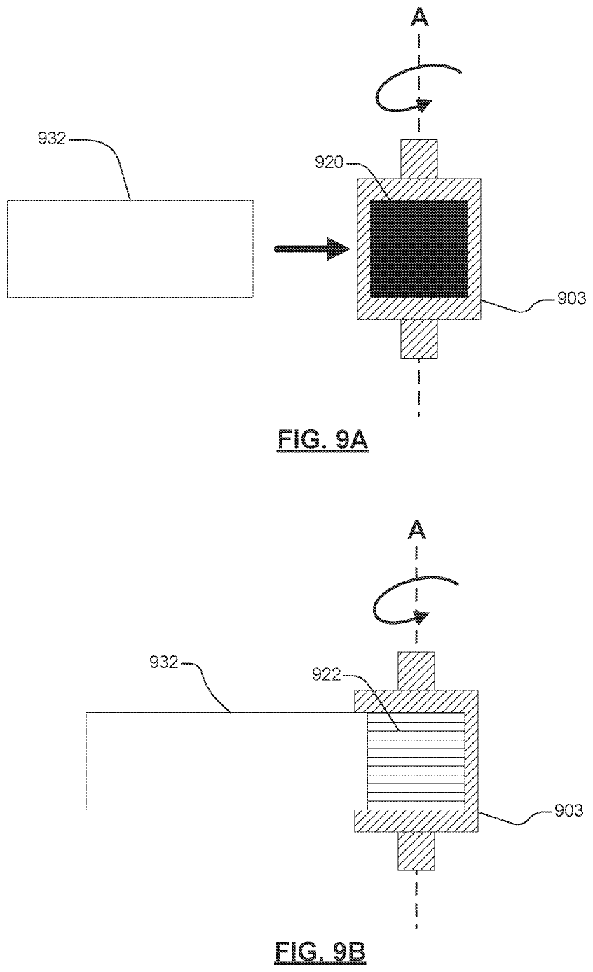

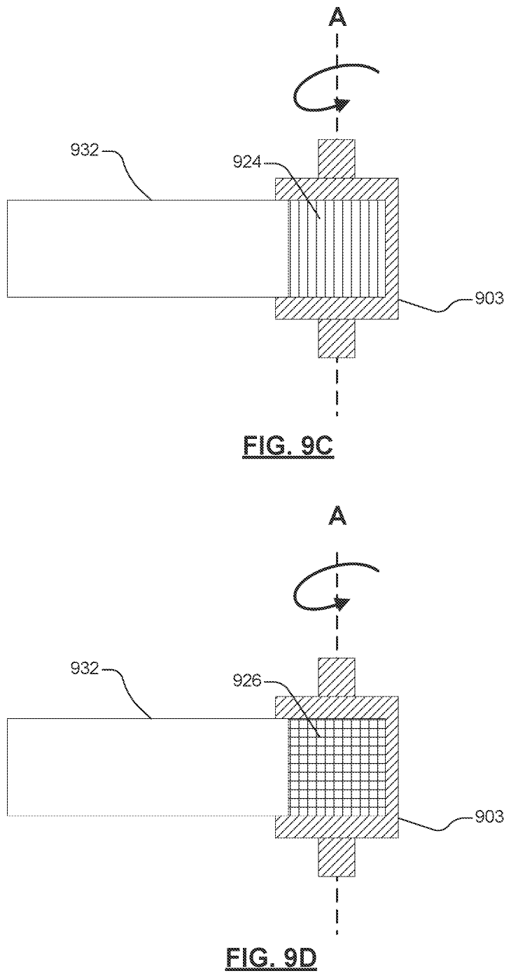

FIG. 4B is a simplified illustration of the winding process 404. FIG. 9A-9D detail more specifically an example winding process. As illustrated in FIG. 9A-9D, winding 404 may include disposing a first cell 920 of the one or more cell units 420 on a stacking platform 903 that is rotatable about an A-axis. A portion of a current collector 932 (for example, current collector 432) is placed onto an exposed surface of the first cell 920. The first cell 920 and the current collector 932 may be wound 180 degrees about the rotational A-axis and a second cell 922 of the one or more cell units 420 is then disposed on an exposed portion of the current collector 932 that is advancing towards the stacking platform 903. The current collector 932 may again wound 180 degrees about the rotational A-axis and a third cell 924 of the one or more cell units 420 is then disposed on an exposed portion of the current collector 932 that is advancing towards the stacking platform 903. The current collector 932 may again wound 180 degrees about the rotational A-axis and a fourth cell 926 of the one or more cell units 420 is then disposed on an exposed portion of the current collector 932 that is advancing towards the stacking platform 903 so as to form the stack 440 illustrated in FIG. 4B. In certain variations, the winding process 404 as illustrated in FIG. 9A-9D may include more or fewer disposing and rotation steps to form stacks having desired characteristics.

With renewed reference to FIGS. 4A-4D, like the current collector 232, the current collector 432 may have a thickness greater than or equal to about 2 μm to less or equal to about 60 μm, and in certain aspects, optionally greater than or equal to about 5 μm to less or equal to about 30 μm. In various aspects, the current collector 432 may a metal foil including at least one of stainless steel, aluminum, nickel, iron, titanium, copper, tin, or any other electrically conductive material known to those of skill in the art. In other variations, the current collector 432 may be a cladded foil, for example, where one side (e.g., the first side or the second side) of the current collector includes one metal (e.g., first metal) and another side (e.g., the other side of the first side or the second side) of the current collector 432 includes another metal (e.g., second metal). The cladded foil may include, for example only, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). In still other variations, the current collector 432 may be pre-coated, such as carbon-coated aluminum current collectors.

Though not illustrated, in various aspects, one or more electrically conductive adhesive layers or coatings may be formed or coated on one or more surfaces of the current collector 432. The one or more electrically conductive adhesive layers may improve connections between the electrodes and the current collectors. In each instance, the electrically conductive adhesive layer may have a thickness greater than or equal to about 0.5 μm to less than or equal to about 20 μm and may include a polymer and a conductive filler. For example, the electrically conductive adhesive layer may include greater than or equal to about 0.1 wt. % to less than or equal to about 50 wt. % of the polymer and greater than or equal to about 0.1 wt. % to less than or equal to about 50 wt. % of the conductive filler.

The polymer may be selected to be solvent resistant and to provide good adhesion. For example, the polymer may include epoxy, polyimide (polyamic acid), polyester, vinyl ester, thermoplastic polymers (e.g., polyvinylidene difluoride (PVDF)), polyamide, silicone, acrylic, polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and any combination thereof. The conductive filler may include carbon materials (e.g., Super P, carbon black, graphene, carbon nanotubes, carbon nanofibers, and the like), metal powders (e.g., gold (Ag), nickel (Ni), aluminum (Al), and the like), and any combination thereof.

With renewed reference to FIGS. 4A-4D, each of the one or more cell units 420 may include a first electrode 442 separated from a second electrode 444 by an electrolyte layer 446. In certain variations, the first electrode 442 may be a negative electrode similar to the negative electrode 22 illustrated in FIG. 1, and the second electrode 444 may be a positive electrode similar to the positive electrode 24 illustrated in FIG. 1. Although not illustrated, the skilled artisan will appreciate that the first electrode 442 may include a first plurality of solid-state electroactive material particles and optionally a first plurality of solid-state electrolyte particles, and the second electrode 444 may include a second plurality of solid-state electroactive material particles and a second plurality of solid-state electrolyte particles. The first and second pluralities of solid-state electrolyte particles may be the same or different.

The skilled artisan will also appreciate that in various aspects the one or more cell units 420 may take a variety of other configurations. For example, in certain variations, the first electrode 442 may be a positive electrode and the second electrode 444 may be a negative electrode. In other variations, the first electrode 442 may include one or more electroactive material layers disposed on one or more surfaces of a second current collector, and the second electrode 444 may include one or more electroactive material layers disposed on one or more surfaces of a third current collector. The second and third current collectors may be the same as or different and may be the same as or different from the continuous bipolar current collector 432. In still further variation, a combination of the one or more cell units 420 may be disposed at each position along the continuous bipolar current collector 432.

In various aspects, the method 400 includes applying 406 pressure and/or heat to the stack 440 to form a compressed stack 450, such as illustrated in FIG. 4C. For example, the stack 440 may be heated to a temperature greater than the glass transition temperature and lower than the melting point of the polymers in the one or more electrically conductive adhesive layers or coatings. The stack 440 may be heated to a temperature greater than or equal to about 50° C. to less than or equal to about 350° C. A pressure applied to the stack 440 may be greater than or equal to about 5 PSI to less than or equal to about 300 PSI. In certain variations, a lamination machine such as a platen may be used to apply 406 the pressure and/or heat to the stack 440.

The method 400 may further include cutting 408 the continuous current collector 432 so as to form the solid-state battery 490, as illustrated in FIG. 4D. The current collector 432 may be trimmed using a machine die cutter and/or a laser cutter.

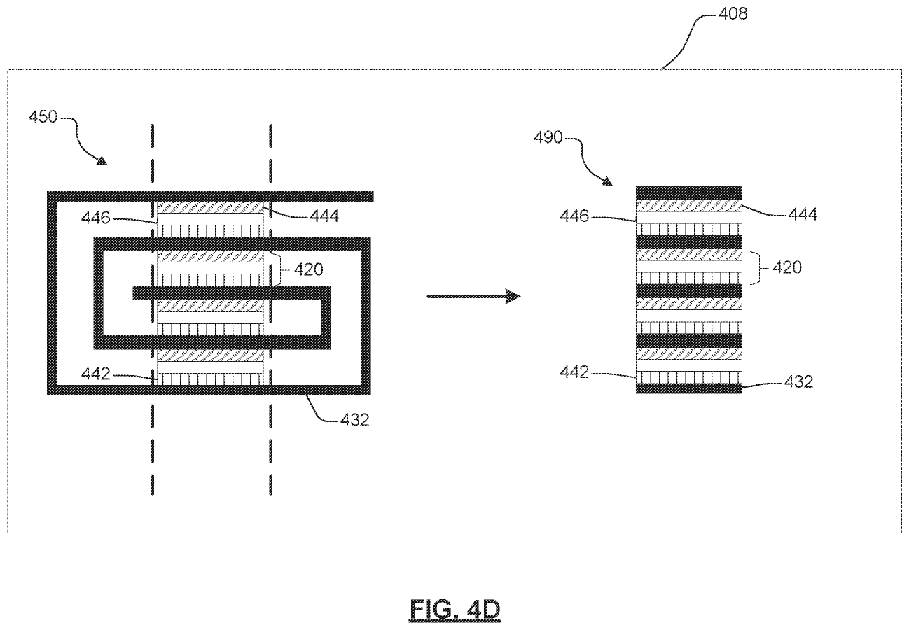

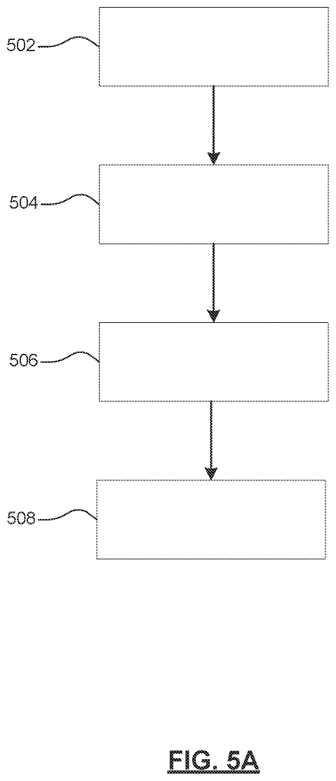

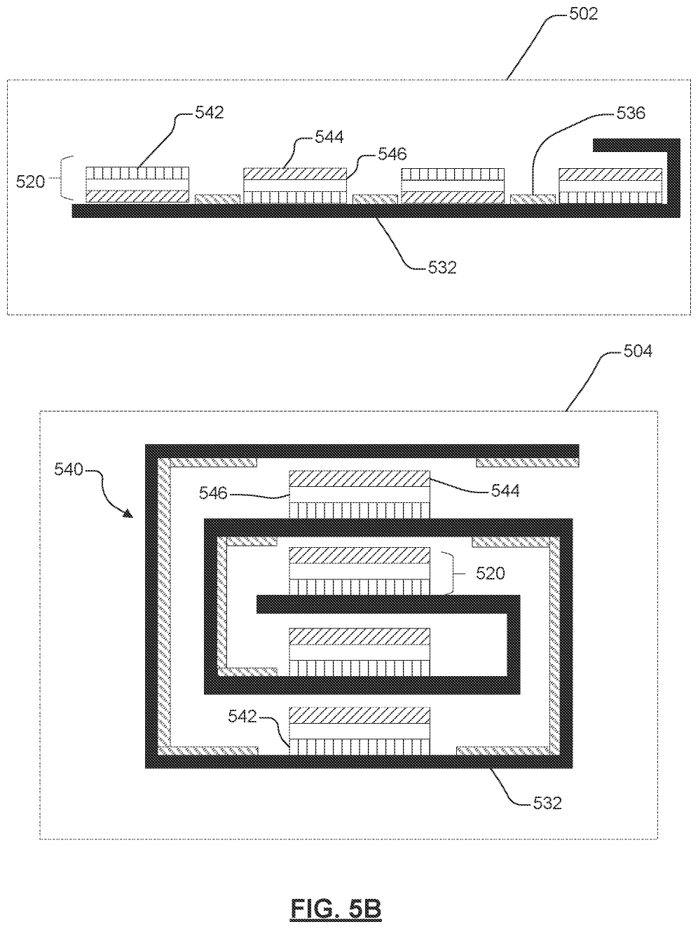

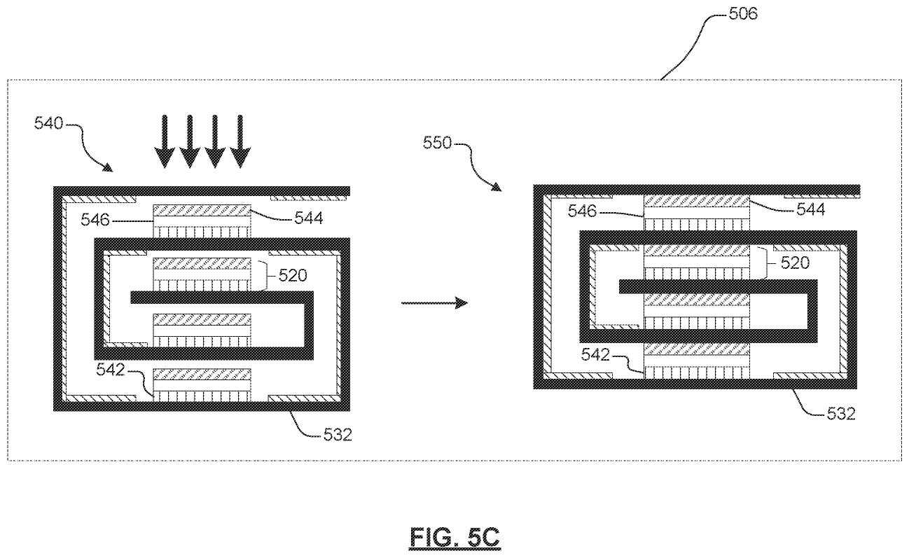

FIGS. 5A-5D illustrate another example winding method 500 for forming a solid-state battery 590. The method 500 includes disposing 502 one or more cell units 520 on or adjacent to a continuous bipolar current collector 532 and concurrently winding 504 the current collector 532 to form a stack 540.

FIG. 5B is a simplified illustration of the winding process 504. FIG. 9A-9D detail more specifically an example winding process. As illustrated in FIG. 9A-9D, winding 504 may include disposing a first cell 920 of the one or more cell units 520 on a stacking platform 903 that is rotatable about an A-axis. A portion of a current collector 932 (for example, current collector 532) is placed onto an exposed surface of the first cell 920. The first cell 920 and the current collector 932 may be wound 180 degrees about the rotational A-axis and a second cell 922 of the one or more cell units 520 is then disposed on an exposed portion of the current collector 932 that is advancing towards the stacking platform 903. The current collector 932 may again wound 180 degrees about the rotational A-axis and a third cell 924 of the one or more cell units 520 is then disposed on an exposed portion of the current collector 932 that is advancing towards the stacking platform 903. The current collector 932 may again wound 180 degrees about the rotational A-axis and a fourth cell 926 of the one or more cell units 520 is then disposed on an exposed portion of the current collector 932 that is advancing towards the stacking platform 903 so as to form the stack 540 illustrated in FIG. 5B. In certain variations, the winding process 504 as illustrated in FIG. 9A-9D may include more or fewer disposing and rotation steps to form stacks having desired characteristics.

With renewed reference to FIGS. 5A-5D, like the current collector 232, the current collector 532 may have a thickness greater than or equal to about 2 μm to less or equal to about 60 μm, and in certain aspects, optionally greater than or equal to about 5 μm to less or equal to about 30 μm. In various aspects, the current collector 532 may a metal foil including at least one of stainless steel, aluminum, nickel, iron, titanium, copper, tin, or any other electrically conductive material known to those of skill in the art. In other variations, the current collector 532 may be a cladded foil, for example, where one side (e.g., the first side or the second side) of the current collector includes one metal (e.g., first metal) and another side (e.g., the other side of the first side or the second side) of the current collector 532 includes another metal (e.g., second metal). The cladded foil may include, for example only, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). In still other variations, the current collector 532 may be pre-coated, such as carbon-coated aluminum current collectors.

Though not illustrated, in various aspects, one or more electrically conductive adhesive layers or coatings may be formed or coated on one or more surfaces of the current collector 532. The one or more electrically conductive adhesive layers may improve connections between the electrodes and the current collectors. In each instance, the electrically conductive adhesive layer may have a thickness greater than or equal to about 0.5 μm to less than or equal to about 20 μm and may include a polymer and a conductive filler. For example, the electrically conductive adhesive layer may include greater than or equal to about 0.1 wt. % to less than or equal to about 50 wt. % of the polymer and greater than or equal to about 0.1 wt. % to less than or equal to about 50 wt. % of the conductive filler.

The polymer may be selected to be solvent resistant and to provide good adhesion. For example, the polymer may include epoxy, polyimide (polyamic acid), polyester, vinyl ester, thermoplastic polymers (e.g., polyvinylidene difluoride (PVDF)), polyamide, silicone, acrylic, polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and any combination thereof. The conductive filler may include carbon materials (e.g., Super P, carbon black, graphene, carbon nanotubes, carbon nanofibers, and the like), metal powders (e.g., gold (Ag), nickel (Ni), aluminum (Al), and the like), and any combination thereof.

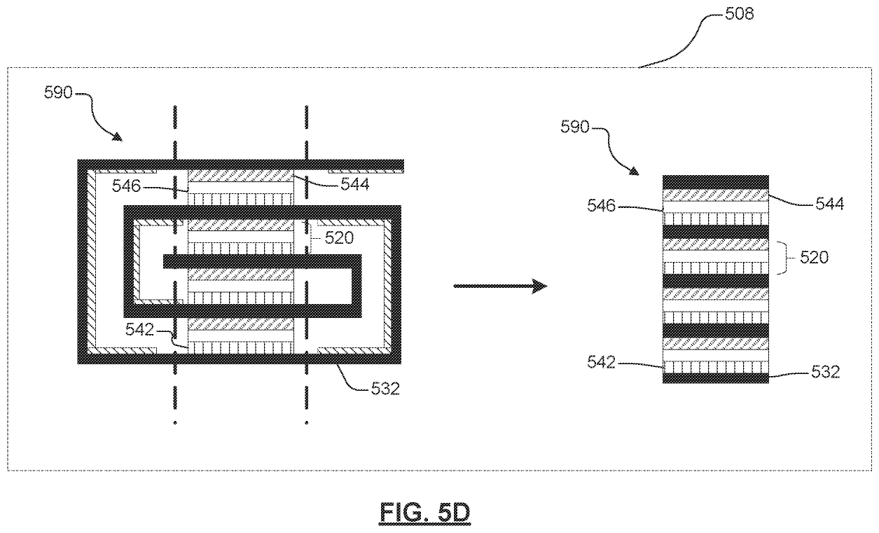

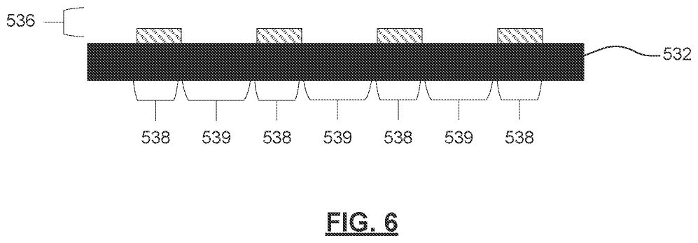

Further still, in each variation, the current collector 532 may include one or more surfaces partially coated with a polymeric coating 536. For example, as illustrated in FIG. 6, the polymeric coating 536 may be disposed on one or more first regions 538 of the current collector 532. As illustrated, the one or more first regions 538 may be separated by one or more second regions 539. As illustrated in FIG. 5B, the one or more first regions 538 may correspond with the folds of the stack 540. For example, the one or more cell units 520 on or adjacent to the second regions 539 of the continuous bipolar current collector 532. The polymeric coating 536 may help maintain the separation between the folds of the stack 540 and may also provide improved adhesive between the layers of the stack 540. Although not illustrated, the skilled artisan will appreciate that in various aspects, the current collector 532 may include one or more anode tabs and/or one or more cathode tabs, such as illustrated in FIG. 9, in addition to the polymeric coating 536. Further, although illustrated in the context of a winding method 600, the skilled artisan will appreciate that a polymeric coating may be similarly used in the instance of z-type stacking processes, such as illustrated in FIGS. 2A-2D.

In each instance, the polymeric coating 536 may have a thickness greater than or equal to about 2 μm to less or equal to about 200 μm. The polymeric coating 536 may include one or more polymeric materials select from a hot-melt adhesive (e.g., urethane resin, polyamide resin, polyolefin resin), polyethylene resin, polypropylene resin, a resin containing an amorphous polypropylene resin as a main component (e.g., obtained by copolymerizing ethylene, propylene, and butane), silicone, polyimide resin, epoxy resin, acrylic resin, rubber (e.g., ethylene-propylenediene rubber (EPDM)), isocyanate adhesive, acrylic resin adhesive, cyanoacrylate adhesive, or any combination thereof.

With renewed reference to FIGS. 5A-5D, each of the one or more cell units 520 may include a first electrode 542 separated from a second electrode 544 by an electrolyte layer 546. In certain variations, the first electrode 542 may be a negative electrode similar to the negative electrode 22 illustrated in FIG. 1, and the second electrode 544 may be a positive electrode similar to the positive electrode 24 illustrated in FIG. 1. Although not illustrated, the skilled artisan will appreciate that the first electrode 542 may include a first plurality of solid-state electroactive material particles and optionally a first plurality of solid-state electrolyte particles, and the second electrode 544 may include a second plurality of solid-state electroactive material particles and a second plurality of solid-state electrolyte particles. The first and second pluralities of solid-state electrolyte particles may be the same or different.

The skilled artisan will also appreciate that in various aspects the one or more cell units 520 may take a variety of other configurations. For example, in certain variations, the first electrode 542 may be a positive electrode and the second electrode 544 may be a negative electrode. In other variations, the first electrode 542 may include one or more electroactive material layers disposed on one or more surfaces of a second current collector, and the second electrode 544 may include one or more electroactive material layers disposed on one or more surfaces of a third current collector. The second and third current collectors may be the same as or different and may be the same as or different from the continuous bipolar current collector 532. In still further variation, a combination of the one or more cell units 520 may be disposed at each position along the continuous bipolar current collector 532.

In various aspects, the method 500 includes applying 506 pressure and/or heat to the stack 540 to form a compressed stack 550, such as illustrated in FIG. 5C. For example, the stack 540 may be heated to a temperature greater than the glass transition temperature and lower than the melting point of the polymers in the one or more electrically conductive adhesive layers or coatings. The stack 540 may be heated to a temperature greater than or equal to about 50° C. to less than or equal to about 350° C. A pressure applied to the stack 540 may be greater than or equal to about 5 PSI to less than or equal to about 300 PSI. In certain variations, a lamination machine such as a platen may be used to apply 506 the pressure and/or heat to the stack 540.

The method 500 may further include cutting 508 the continuous current collector 532 so as to form the solid-state battery 590, as illustrated in FIG. 5D. The current collector 532 may be trimmed using machine die cutter and/or a laser cutter.

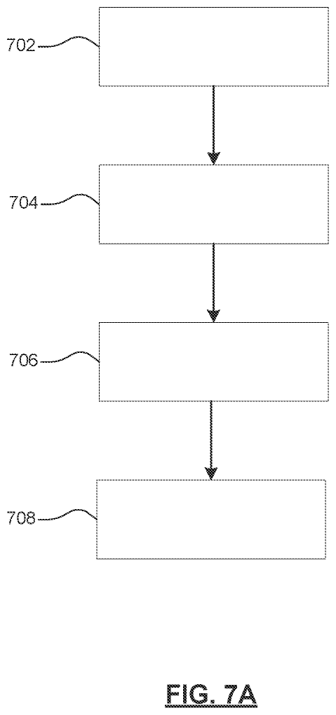

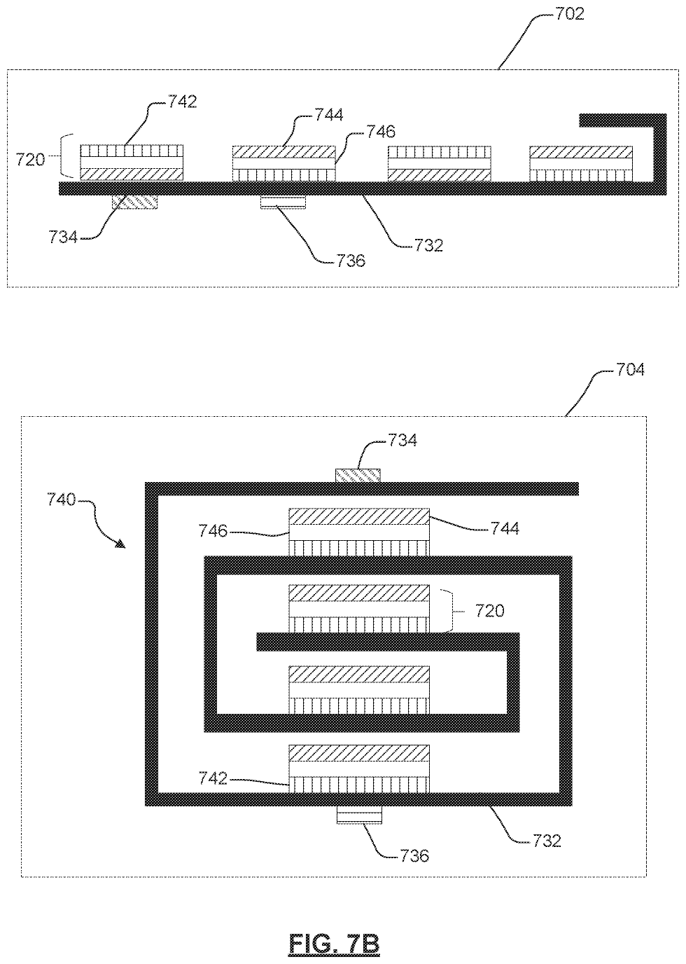

FIGS. 7A-7D illustrate another example winding method 700 for forming a solid-state battery 790. The method 700 includes disposing 702 one or more cell units 720 on or adjacent to a continuous bipolar current collector 732 and concurrently winding 704 the current collector 732 to form a stack 740.

FIG. 7B is a simplified illustration of the winding process 704. FIG. 9A-9D detail more specifically an example winding process. As illustrated in FIG. 9A-9D, winding 704 may include disposing a first cell 920 of the one or more cell units 720 on a stacking platform 903 that is rotatable about an A-axis. A portion of a current collector 932 (for example, current collector 732) is placed onto an exposed surface of the first cell 920. The first cell 920 and the current collector 932 may be wound 180 degrees about the rotational A-axis and a second cell 922 of the one or more cell units 720 is then disposed on an exposed portion of the current collector 932 that is advancing towards the stacking platform 903. The current collector 932 may again wound 180 degrees about the rotational A-axis and a third cell 924 of the one or more cell units 720 is then disposed on an exposed portion of the current collector 932 that is advancing towards the stacking platform 903. The current collector 932 may again wound 180 degrees about the rotational A-axis and a fourth cell 926 of the one or more cell units 720 is then disposed on an exposed portion of the current collector 932 that is advancing towards the stacking platform 903 so as to form the stack 740 illustrated in FIG. 7B. In certain variations, the winding process 704 as illustrated in FIG. 9A-9D may include more or fewer disposing and rotation steps to form stacks having desired characteristics.

With renewed reference to FIGS. 7A-7D, like the current collector 232, the current collector 732 may have a thickness greater than or equal to about 2 μm to less or equal to about 60 μm, and in certain aspects, optionally greater than or equal to about 5 μm to less or equal to about 30 μm. In various aspects, the current collector 732 may a metal foil including at least one of stainless steel, aluminum, nickel, iron, titanium, copper, tin, or any other electrically conductive material known to those of skill in the art. In other variations, the current collector 732 may be a cladded foil, for example, where one side (e.g., the first side or the second side) of the current collector includes one metal (e.g., first metal) and another side (e.g., the other side of the first side or the second side) of the current collector 732 includes another metal (e.g., second metal). The cladded foil may include, for example only, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). In still other variations, the current collector 732 may be pre-coated, such as carbon-coated aluminum current collectors.

Though not illustrated, in various aspects, one or more electrically conductive adhesive layers or coatings may be formed or coated on one or more surfaces of the current collector 732. The one or more electrically conductive adhesive layers may improve connections between the electrodes and the current collectors. In each instance, the electrically conductive adhesive layer may have a thickness greater than or equal to about 0.5 μm to less than or equal to about 20 μm and may include a polymer and a conductive filler. For example, the electrically conductive adhesive layer may include greater than or equal to about 0.1 wt. % to less than or equal to about 50 wt. % of the polymer and greater than or equal to about 0.1 wt. % to less than or equal to about 50 wt. % of the conductive filler.

The polymer may be selected to be solvent resistant and to provide good adhesion. For example, the polymer may include epoxy, polyimide (polyamic acid), polyester, vinyl ester, thermoplastic polymers (e.g., polyvinylidene difluoride (PVDF)), polyamide, silicone, acrylic, polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and any combination thereof. The conductive filler may include carbon materials (e.g., Super P, carbon black, graphene, carbon nanotubes, carbon nanofibers, and the like), metal powders (e.g., gold (Ag), nickel (Ni), aluminum (Al), and the like), and any combination thereof.

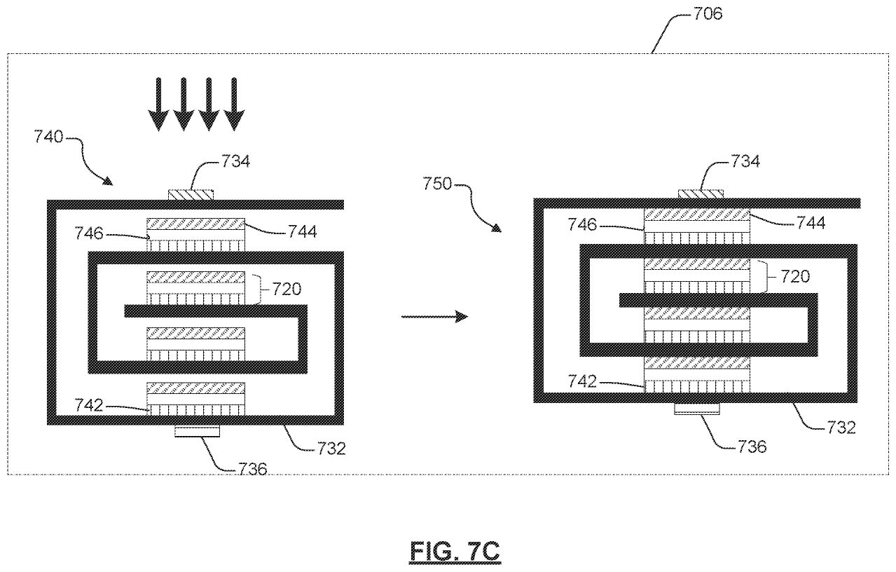

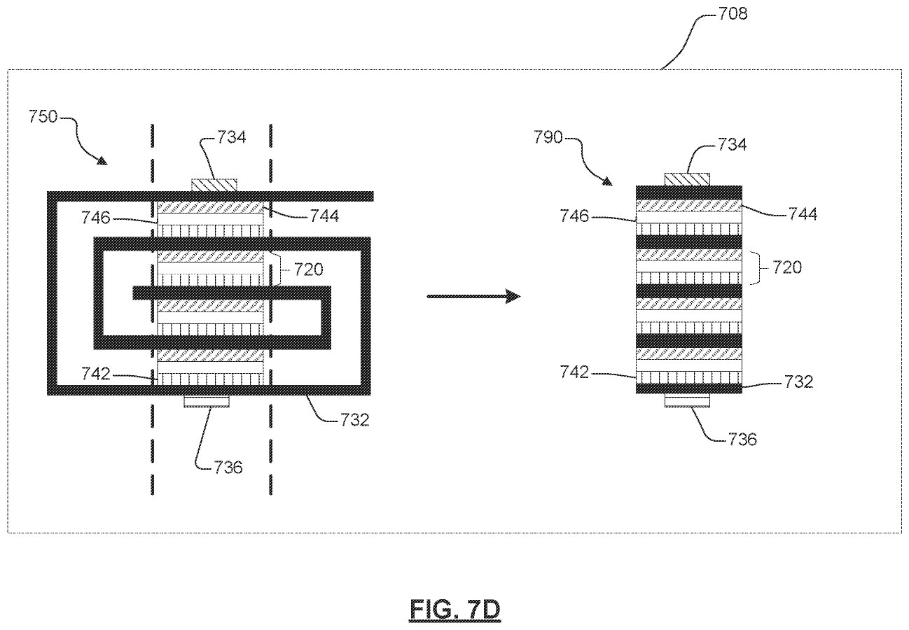

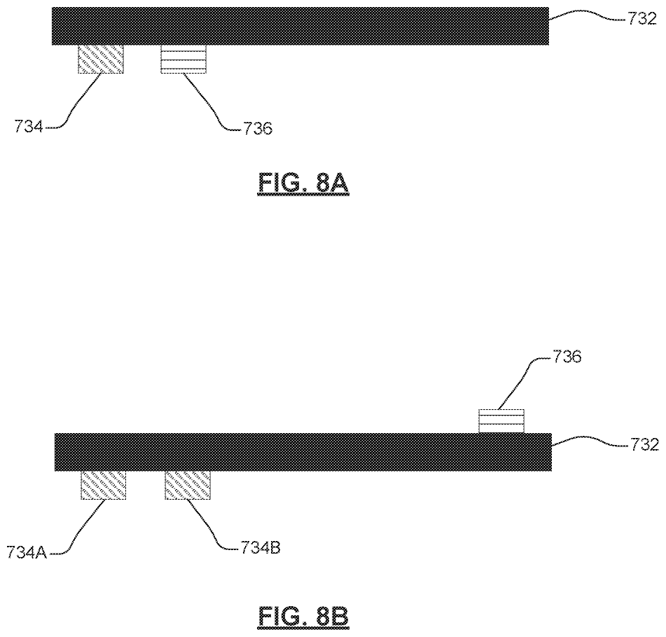

In each variation, one or more anode tabs 734 and/or one or more cathode tabs 736 may be defined in the continuous current collector 732. For example, the one or more anode tabs 734 and/or one or more cathode tabs 736 may be part of the continuous current collector 732 where material surrounding the one or more anode tabs 734 and/or one or more cathode tabs 736 has been removed. In certain variations, as illustrated in FIG. 8A, and FIGS. 7B-7D, a cathode tab 736 may extend from a first end of the continuous current collector 732 and an anode tab 734 may extend from a position adjacent to first end and the cathode tab 736. In such instances, the solid-state battery 790 may have a positive end and a negative end. In other example variations, as illustrated in FIG. 8B, first and second anode tabs 734A, 734B may extend from a first end of the continuous current collector 732 and a cathode tab 736 may extend from an opposing or second end of the continuous current collector 732. In such instances, the solid-state battery 790 may have opposing negative ends and a positive connect extending from a center position therebetween. Although not illustrated, the skilled artisan will appreciate that the continuous current collector 732 may have a variety of other configurations including the one or more anode tabs 734 and/or the one or more cathode tabs 736 disposed at different points along the continuous current collector 732, and also, in different relative positions. Further, the skilled artisan will appreciate that in various aspects, the current collector 732 may include a polymeric coating, such as illustrated in FIG. 6, in addition to the one or more anode tabs 734 and/or the one or more cathode tabs 736.

With renewed reference to FIGS. 7A-7D, each of the one or more cell units 720 may include a first electrode 742 separated from a second electrode 744 by an electrolyte layer 746. In certain variations, the first electrode 742 may be a negative electrode similar to the negative electrode 22 illustrated in FIG. 1, and the second electrode 744 may be a positive electrode similar to the positive electrode 24 illustrated in FIG. 1. Although not illustrated, the skilled artisan will appreciate that the first electrode 742 may include a first plurality of solid-state electroactive material particles and optionally a first plurality of solid-state electrolyte particles, and the second electrode 744 may include a second plurality of solid-state electroactive material particles and a second plurality of solid-state electrolyte particles. The first and second pluralities of solid-state electrolyte particles may be the same or different.

The skilled artisan will also appreciate that in various aspects the one or more cell units 720 may take a variety of other configurations. For example, in certain variations, the first electrode 742 may be a positive electrode and the second electrode 744 may be a negative electrode. In other variations, the first electrode 742 may include one or more electroactive material layers disposed on one or more surfaces of a second current collector, and the second electrode 744 may include one or more electroactive material layers disposed on one or more surfaces of a third current collector. The second and third current collectors may be the same as or different and may be the same as or different from the continuous bipolar current collector 732. In still further variation, a combination of the one or more cell units 720 may be disposed at each position along the continuous bipolar current collector 732.

In various aspects, the method 700 includes applying 706 pressure and/or heat to the stack 740 to form a compressed stack 750, such as illustrated in FIG. 5C. For example, the stack 740 may be heated to a temperature greater than the glass transition temperature and lower than the melting point of the polymers in the one or more electrically conductive adhesive layers or coatings. The stack 740 may be heated to a temperature greater than or equal to about 50° C. to less than or equal to about 350° C. A pressure applied to the stack 740 may be greater than or equal to about 5 PSI to less than or equal to about 300 PSI. In certain variations, a lamination machine such as a platen may be used to apply 706 the pressure and/or heat to the stack 740.

The method 700 may further include cutting 708 the continuous current collector 732 so as to form the solid-state battery 790, as illustrated in FIG. 7D. The current collector 732 may be trimmed using machine die cutter and/or a laser cutter.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming a solid-state battery, the method comprising:
disposing one or more cell units along a continuous current collector to form a stack precursor, wherein each cell unit comprises one or more first electrodes, one or more second electrodes, and one or more electrolyte layers physically separating the one or more first electrodes and the one or more second electrodes;
applying heat, pressure, or a combination of heat and pressure to the stack precursor to form a compressed stack; and
cutting the continuous current collector to form the solid-state battery.

2. The method of claim 1, wherein the disposing of the one or more cell units along the continuous current collector comprises concurrently disposing the one or more cell units along the continuous current collector and winding the continuous current collector to form a stack.

3. The method of claim 2, wherein the concurrently disposing of the one or more cell units along the continuous current collector and winding the continuous current collector to form the stack comprises:
disposing a first cell of the one or more cell units on a first exposed surface of the continuous current collector;
winding the continuous current collector 180 degrees about a central axis so to expose a second exposed surface of the continuous current collector;
disposing a second cell of the one or more cell units on a second exposed surface of the continuous current collector; and
winding the continuous current collector 180 degrees about a central axis so to expose a third exposed surface of the continuous current collector.

4. The method of claim 1, wherein the continuous current collector is a z-folded current collector and the disposing the one or more cell units along the continuous current collector comprises:
inserting the one or more cell units into one or more pockets formed by folds of the continuous current collector.

5. The method of claim 1, wherein the disposing of the one or more cell units along the continuous current collector comprises:
disposing a first cell unit of the one or more cell units on or adjacent to a first surface of the continuous current collector;
folding the continuous current collector to form a first pocket that surrounds the first cell unit;
disposing a second cell unit of the one or more cell units on or adjacent to a second surface of the continuous current collector that is defined by an exterior-facing surface of the first pocket; and
folding the continuous current collector to form a second pocket that surrounds the second cell unit.

6. The method of claim 1, wherein the continuous current collector has a thickness greater than or equal to about 2 μm to less or equal to about 60 μm.

7. The method of claim 1, wherein the continuous current collector is a cladded foil comprising a first layer parallel with a second layer.

8. The method of claim 1, wherein one or more anode tabs and one or more cathode tabs are defined in the continuous current collector.

9. The method of claim 1, wherein the continuous current collector comprises one or more surfaces at least partially coated with one or more electrically conductive adhesive layers.

10. The method of claim 1, wherein the continuous current collector comprises one or more surfaces partially coated with a polymeric coating having a thickness greater than or equal to about 2 μm to less or equal to about 200 μm.

11. The method of claim 1, wherein the method further comprises:
disposing a polymeric coating on one or more first regions of a first surface of the continuous current collector, wherein the one or more first regions are spaced apart by one or more second regions and the one or more cell units are disposed on or adjacent to the one or more second regions and cutting the continuous current collector removes at least a portion of each of the one or more polymeric coatings.

12. The method of claim 11, wherein the polymeric coating comprises one or more polymeric materials selected from the group consisting of: urethane resin, polyamide resin, polyolefin resin, polyethylene resin, polypropylene resin, silicone, polyimide resin, epoxy resin, acrylic resin, ethylene-propylenediene rubber (EPDM), isocyanate adhesive, acrylic resin adhesive, cyanoacrylate adhesive, or any combination thereof.

13. The method of claim 1, wherein the stack precursor is heated to a temperature greater than or equal to about 50° C. to less than or equal to about 350° C. to form the compressed stack.

14. The method of claim 1, where a pressure greater than or equal to about 5 PSI to less than or equal to about 300 PSI is applied to the stack precursor to form the compressed stack.

15. A method for forming a solid-state battery, the method comprising:
disposing one or more cell units along a continuous current collector and concurrently winding the continuous current collector to form a stack precursor, wherein each cell unit comprises one or more first electrodes, one or more second electrodes, and one or more electrolyte layers physically separating the one or more first electrodes and the one or more second electrodes;
applying heat, pressure, or a combination of heat and pressure to the stack precursor to form a compressed stack, wherein applying heat comprises heating the stack to a temperature greater than or equal to about 50° C. to less than or equal to about 350° C. and applying pressure comprises pressing the stack at a pressure greater than or equal to about 5 PSI to less than or equal to about 300 PSI; and
cutting the continuous current collector us to form the solid-state battery.

16. The method of claim 15, wherein the current collector is one of a metal foil and a cladded foil, and one or more anode tabs and one or more cathode tabs are defined in the continuous current collector.

17. The method of claim 16, wherein the method further comprises:
disposing a polymeric coating on one or more first regions of a first surface of the continuous current collector, wherein the one or more first regions are spaced apart by one or more second regions and the one or more cell units are disposed on or adjacent to the one or more second regions and cutting the continuous current collector removes at least a portion of each of the one or more polymeric coatings.

18. A method of forming a solid-state battery, the method comprising:
disposing one or more cell units along a first surface of a continuous current collector to form a stack precursor, wherein the continuous current collector is a z-folded current collector and each cell unit comprises one or more first electrodes, one or more second electrodes, and one or more electrolyte layers physically separating the one or more first electrodes and the one or more second electrode;
applying heat, pressure, or a combination of heat and pressure to the stack precursor to form a compressed stack, wherein applying heat comprises heating the stack to a temperature greater than or equal to about 50° C. to less than or equal to about 350° C. and applying pressure comprises pressing the stack at a pressure greater than or equal to about 5 PSI to less than or equal to about 300 PSI; and
cutting the continuous current collector to form the solid-state battery.

19. The method of claim 18, wherein the current collector is one of a metal foil and a cladded foil and one or more anode tabs and one or more cathode tabs are defined in the continuous current collector.

20. The method of claim 18, wherein the method further comprises:
disposing a polymeric coating on one or more first regions of a first surface of the continuous current collector, wherein the one or more first regions are spaced apart by one or more second regions and the one or more cell units are disposed on or adjacent to the one or more second regions and cutting the continuous current collector removes at least a portion of each of the one or more polymeric coatings.
